(19) United States
(12) Patent Application Publication
(10) Pub. No.: US 2026/0356534 A1
(43) Pub. Date: Nov. 12, 2026

(54) A TRAY AND A METHOD FOR FORMING A TRAY

(71) Applicant: Stora Enso OYJ, Heisinki (FI)

(72) Inventor: Petri Aalto, Talma (FI)

(73) Assignee: Stora Enso OYJ, Heisinki (FI)

(21) Appl. No.: 19/137,894

(22) PCT Filed: Dec. 11, 2023
(86) PCT No.: PCT/IB2023/062475

§ 371 Date: Jun. 11, 2025

(30) Foreign Application Priority Data
Dec. 12, 2022 (SE) 2230408-3

(51) Int. Cl. B65D 5/20; B31B 50/72; B31B 100/00; B31B 110/10; B31B 120/10; B31B 120/40; B65D 5/42; B65D 5/56; B65D 77/20

(52) U.S. Cl. CPC B65D 5/2047; B31B 50/724; B65D 5/4283; B65D 5/56; B65D 77/2024; B31B 2100/0024; B31B 2110/10; B31B 2120/102; B31B 2120/402

(57) ABSTRACT

A tray formed from a blank (100) comprising: a bottom panel (102); two opposing longitudinal side wall panels (104a-b); two opposing transversal side wall panels (106a-b); two opposing longitudinal rim panels (108a-b); and two opposing transversal rim panels (110a-b), wherein the side wall panels (104a-b, 106a-b) are folded upwardly relative to the bottom panel (102) to form a respective side wall of the tray, and thereby forming corners in geometrical intersections between the adjacent side wall panels, wherein the rim panels are folded outwardly or inwardly relative to the respective side wall to form a circumferential rim of the tray, and wherein, at at least a first, second third and fourth corner of the tray, one or more plastic pieces is/are attached at least to a first corner portion of the two longitudinal rim panels and to a first and second corner portion, respectively, of one of the two transversal rim panels such that said rim panels are interconnected at the first and second corner by said plastic film. The disclosure also relates to a method for forming a tray.

### FIELD OF THE INVENTION

The invention relates to a tray formed from a blank. The invention also relates to a method for forming a tray.

### BACKGROUND ART

When designing a tray from a blank, it is often desirous to take into account a number of different design criteria. The tray should e.g. often be designed such that it makes efficient use of the material, is easy to prepare before use, is easy to store before use, and provides a strong structure. It is often desirable that it is strong during handling and stable in a folded state. The tray should preferably be designed in a cost-efficient manner. The tray should e.g. also be designed such that it is easy to recycle. Moreover, it should often be capable of being folded into a tray and used as a tray without the use of any adhesive or any similar means of keeping the tray folded, or at least with a minimum use of such adhesive or similar means.

However, one drawback with the trays of today is that the trays may be made of non-renewable materials or non-environmentally friendly materials. A further drawback with the trays of today is that the trays may be difficult to transport and difficult to produce.

In an attempt to address some parts of these issues, document EP 2 441 697 B1 discloses a box formed from a sheet, e.g. a cardboard sheet, with flange parts, wherein adjacent flange parts abut to compose an endless circumferential flange, and a plastic foil laminated to the inner wall of the box and extends over the circumferential flange.

However, even though the solution disclosed by EP 2 441 697 B1 addresses some parts of the above issues, there is still a need in the art for improvements, e.g., in terms of an alternative design and improved robustness of the tray.

### SUMMARY OF THE INVENTION

It is an object to mitigate, alleviate, or eliminate one or more of the above-identified deficiencies in the art.

According to a first aspect, there is provided a tray formed from a blank, the blank comprising:
a bottom panel;
two opposing longitudinal side wall panels being foldably connected to a respective one of two opposing longitudinally extending sides of the bottom panel;
two opposing transversal side wall panels being foldably connected to a respective one of two opposing transversely extending sides of the bottom panel;
two opposing longitudinal rim panels being foldably connected to a respective one of the two opposing longitudinal side wall panels on a longitudinally extending side of the respective longitudinal side wall panels being opposite the bottom panel, and
two opposing transversal rim panels being foldably connected to a respective one of the two opposing transversal side wall panels on a transversely extending side of the respective transversal side wall panel being opposite the bottom panel,
wherein the two opposing longitudinal side wall panels and the two opposing transversal side wall panels are folded upwardly relative to the bottom panel to form a respective side wall of the tray,
wherein, when the side wall panels are folded upwardly to form the respective side wall of the tray, substantially transversely extending end sides, as seen in a flat-laid state of the blank, of the two opposing longitudinal side wall panels each extend along a respective one of the two opposing transversal side wall panels or along a respective substantially longitudinally extending end side of the two opposing transversal side wall panels, or vice versa, and thereby form corners in geometrical intersections between the adjacent side wall panels,
wherein the two opposing longitudinal rim panels and the two opposing transversal rim panels are folded outwardly or inwardly relative to the respective side wall of the tray to form a circumferential rim of the tray, wherein the longitudinal and transversal rim panels each comprises a first and a second corner portion arranged on opposite sides of a respective central portion as seen along a respective main extension of the respective rim panel,
wherein one or more plastic film pieces is/are attached to the respective rim panel at at least a first, second, third and fourth corner of the tray, wherein the one and more plastic film pieces is/are attached at least to the respective first corner portion of the two opposing longitudinal rim panels and to the first and second corner portions, respectively, of one of the two opposing transversal rim panels such that said rim panels are interconnected at the first and second corner by said plastic film,
wherein the one or more plastic film pieces is/are attached at least to the respective second corner portion of the two opposing longitudinal rim panels and to the first and second corner portions, respectively, of one of the two opposing transversal rim panels such that said rim panels are interconnected at the third and fourth corner by said plastic film,
wherein the one or more plastic film pieces is/are only attached to said longitudinal and said transversal rim panels, and
wherein the blank is made of a paper-based material, such as a corrugated paperboard or a solid paperboard, having a grammage in the range of 180-600 g/m², preferably in the range of 240 to 450 g/m².

With such a design, there is provided a tray formed from a blank, wherein the blank has a bottom panel, side wall panels and rim panels. Thus, the tray is formed from one single blank. With the disclosed design, especially in an embodiment where one blank comprises all components, it is facilitated to provide a tray which makes efficient use of the material and at the same time is easy to fold into the tray. It is preferred that the bottom panel, the side wall panels, and the rim panels extend along a single common plane, as seen in a flat-laid state of the blank.

With such a design, where the plastic film is attached to the first corner portions such that the rim panels are interconnected at the first corner of the tray by the plastic film, there is provided a tray which make efficient use of both the material of the blank but also of the material of the plastic film. There is also provided a tray having a strong and stable but also a robust structure. Thus, by attaching the plastic film to the first corner fulfills stability and strength requirements related to the tray such that the tray is able to be used in a desired way. There is also provided a tray which is easy to recycle in a desired way, wherein the plastic film may be torn off the blank such that the blank and the plastic film may be recycled separately.

Further, with such a design, there is provided an easy and efficient solution of keeping the tray in the folded state. This facilitates provision of keeping the tray in the folded state without the use of any adhesive or similar means, or at least with a minimum use of such adhesive or similar means. In this context, the term “attaching the plastic film” may be referred to as laminating the plastic film to the tray. This further facilitates provision of a tray which comprises good preprinting or post printing properties over almost all surfaces of the tray, for e.g. information and marketing without addition sleeve or stickering/labelling.

In this context, it may be noted that in a preferred embodiment, the plastic film is only attached to the first corner portion of one of the two opposing longitudinal rim panels and to the first corner portion of one of the two opposing transversal rim panels. With such a design, the rim panels are interconnected only at the first corner of the tray by the plastic film. Further, with such a design, the plastic film is not attached to any other components of the tray. It may in this context be noted that only to the corner portion of a rim refers to the fact that there is in such an embodiment a central portion of the respective rim panel without any plastic film taking part in the interconnection of the rim panels. However, at the end there might be a plastic film forming part of a top sealing also along those central portions. Central portion refers to a portion being central as seen along the main extension of the rim panel.

In this context, it may be noted that in a preferred embodiment, the tray has four corners. Thus, alternatively, or additionally, at a second corner of the tray, the plastic film may be attached to a first corner portion of another one of the two opposing longitudinal rim panels and to a second corner portion of the one of the two opposing transversal rim panels such that the rim panels are interconnected at the second corner by said plastic film. In this context, it may be noted that in a preferred embodiment, the plastic film is only attached to the first corner portion of the other one of the two opposing longitudinal rim panels and to the second corner portion of the one of the two opposing transversal rim panels. With such a design, the rim panels are interconnected only at the second corner of the tray by the plastic film. Further, with such a design, the plastic film is not attached to any other components of the tray.

Alternatively, or additionally, at a third corner of the tray, the plastic film may be attached to a second corner portion of one of the two opposing longitudinal rim panels and to a first corner portion of another one of the two opposing transversal rim panels such that the rim panels are interconnected at the third corner by the plastic film. In this context, it may be noted that in a preferred embodiment, the plastic film is only attached to the second corner portion of one of the two opposing longitudinal rim panels and to the first corner portion of the other one of the two opposing transversal rim panels. With such a design, the rim panels are interconnected only at the third corner of the tray by the plastic film. Further, with such a design, the plastic film is not attached to any other components of the tray.

Alternatively, or additionally, at a fourth corner of the tray, the plastic film may be attached to a second corner portion of another one of the two opposing longitudinal rim panels and to a second corner portion of the one of the other one of the two opposing transversal rim panels such that the rim panels are interconnected at the fourth corner by the plastic film. In this context, it may be noted that in a preferred embodiment, the plastic film is only attached to the second corner portion of the other one of the two opposing longitudinal rim panels and to the second corner portion of the one of the two opposing transversal rim panels. With such a design, the rim panels are interconnected only at the fourth corner of the tray by the plastic film. Further, with such a design, the plastic film is not attached to any other components of the tray.

In a preferred embodiment, the rim panels are only interconnected at one corner of the plurality of corners of the tray by the plastic film. It should be understood by the skilled person that when the rim panels are interconnected only at one corner by the plastic film, the plastic film is not attached to the other corners, along the rim panels, at corner portions of the side wall panels, along the side wall panels or at the bottom panel of the tray.

The rim panels may be interconnected at more than one corner of the tray by the plastic film. It should be noted that the “first, second, third, and fourth” should only be seen as labels and the first corner may be any corner of the above alternative etc.

It may be noted that the side walls need not be folded to form a right angle with the bottom panel. On the contrary, it is actually preferred that the side walls are folded an angle being slightly less than 90 degrees such that the side walls extends substantially upwardly and flares slightly outwardly. This is advantageous as it allows for that a plurality of trays may be stacked one on top of the other in an easy and efficient way. By being able to provide for an easy stacking of the plurality of trays, the trays may be easy to transport to a desired location before they are filled with a desired content.

In this context, the term “substantially transversely” should be interpreted as the end sides of the longitudinal side wall panels need not be designed to form a right angle with the respective longitudinal extending side of the bottom panel. Instead, the end sides of the longitudinal side wall panels preferably form an obtuse angle, being greater than 90 degrees, with the respective longitudinal extending side of the bottom panel, as seen in the flat laid state. In this context, the term “substantially longitudinally” should be interpreted as the end sides of the transversal side wall panels need not be designed to form a right angle with the respective transversely extending side of the bottom panel. Instead, the end sides of the transversal side wall panels preferably form an obtuse angle, being greater than 90 degrees, with the respective transversely extending side of the bottom panel, as seen in the flat laid state.

With such a design, where the side wall panels are folded upwardly to form a respective side wall of the tray and forms corners in geometrical intersections between the adjacent side wall panels, there is provided a tray in which the side wall panels does not overlap each other. Thus, there is provided a tray in which no double material corners are provided. Actually, no panels of the blank are overlapping each other when the blank is folded to form the tray. This is advantageous as it allows for efficient use of the material at the same time as an easy stacking of a plurality of trays is achieved.

In this context it may be noted that there are several different variants available within the definition of “substantially transversely extending end sides of the two opposing longitudinal side wall panels each extend along a respective one of the two opposing transversal side wall panels or along a respective longitudinally extending end side of the two opposing transversal side wall panels, or vice versa”. In a first variant, both the transversal and longitudinal side wall panels have end sides that are cut such that they extend alongside each other along the upward extension of the corner. In a second variant, the transversal side walls have a transversal extension exceeding the transversal distance between the intended corners, whereby the transversally extending ends sides of the longitudinal side walls will extend along, or even abut, inwardly facing major surfaces of the transversal side walls. In a third variant, the longitudinal side walls have a longitudinal extension exceeding the longitudinal distance between the intended corners, whereby the longitudinally extending end sides of the transversal side walls will extend along, or even abut, inwardly facing major surfaces of the longitudinal side walls. In the second or third variant, further variants may be found in that the extension exceeding the distance between the intended corners may be just sufficient to present inwardly facing major surfaces or may alternatively be greater than that so that wing-line structures are formed on the outside of the corners. It may also be noted that all these different variants may be combined such that different design is applied e.g., at different sides or even at each corner.

The tray is further advantageous as it is possible to design it in a various of way, both relating to shape and size. This facilitates provision of a scalable concept. The tray is further advantageous as it allows to replace plastic trays, which typically are used today, with the disclosed tray, which is both environmentally-friendly and a robust tray.

At a second corner of the tray, the plastic film may be further attached to a first corner portion of another one of the two opposing longitudinal rim panels and to a second corner portion of said one of the two opposing transversal rim panels such that said rim panels are interconnected at the second corner by said plastic film, and
wherein, the plastic film may be further attached to said one of the two opposing transversal rim panels, between the first corner and the second corner of the tray.

With such a design, where the plastic film is attached to the second corner of the tray and to one of the two opposing transversal rim panels, between the first and second corner, there is provided an improved strength and stability of the tray, both when stacking one tray on top of the other but also when filling the tray with the desired content. In this context, it may be noted that in a preferred embodiment, the plastic film is only attached to the rim panels at the first and second corner of the tray and to one of the two transversal rim panels, between the first and second corners. Thus, the plastic film is not attached to the other corners of the tray or along other rim panels. The plastic film is neither attached to corner portions of the side wall panels, to the side wall panels or to the bottom panel of the tray.

Alternatively, or additionally, at a third corner of the tray, the plastic film may be attached to a second corner portion of one of the two opposing longitudinal rim panels and to a first corner portion of another one of the two opposing transversal rim panels such that the rim panels are interconnected at the third corner by the plastic film. Alternatively, or additionally, at a fourth corner of the tray, the plastic film may be attached to a second corner portion of another one of the two opposing longitudinal rim panels and to a second corner portion of the one of the other one of the two opposing transversal rim panels such that the rim panels are interconnected at the fourth corner by the plastic film. Additionally, the plastic film is further attached to the other one of the two opposing transversal rim panels, between the third corner and the fourth corner of the tray. With such a design, it should be noted that the plastic film is not attached to longitudinal rim panels, to the corner portions of the side wall panels, to the side wall panels or to the bottom panel of the tray. Thus, the plastic film is only attached to the four corners, interconnecting the respective rim panel, and along the transversal rim panels.

Alternatively, or additionally, at the third corner of the tray, the plastic film is attached to a second corner portion of one of the two opposing longitudinal rim panels and to a first corner portion of another one of the two opposing transversal rim panels such that the rim panels are interconnected at the third corner by the plastic film. Additionally, the plastic film is attached to the one of the two opposing longitudinal rim panels, between the first corner and third corner or between the second corner and third corner of the tray. With such a design, it should be noted that the plastic film is not attached to the other transversal rim panel, the other longitudinal rim panels, to the corner portions of the side wall panels, or to the side wall panels or to the bottom panel of the tray. Thus, the plastic film is only attached to the three corners, interconnecting the respective rim panel, along one of the transversal rim panels and along one of the longitudinal rim panels.

In this context, it may be noted that there are several different variants available within the definition of “second corner of the tray”, wherein the first variant is stated above. In a second variant, the plastic film is attached to a second corner portion of the one of the two opposing longitudinal rim panels and to a first corner portion of another one of the two opposing transversal rim panels such that the rim panels are interconnected at the second corner by the plastic film. In this variant, the plastic film may further be attached to the one of the two opposing longitudinal rim panels, between the first corner and second corner of the tray. In this context, it may be noted that in a preferred embodiment, the plastic film is only attached to the rim panels at the first and second corner of the tray and to one of the two longitudinal rim panels, between the first and second corner. Thus, the plastic film is not attached to other corners of the tray or along other rim panels. The plastic film is neither attached to the corner portions of the side wall panels, to the side wall panels or to the bottom panel of the tray.

Alternatively, or additionally, at the third corner of the tray, the plastic film is attached to a first corner portion of another one of the two opposing longitudinal rim panels and to a second corner portion of one of the two opposing transversal rim panels such that the rim panels are interconnected at the third corner by the plastic film. Alternatively, or additionally, at the fourth corner of the tray, the plastic film may be attached to a second corner portion of the other one of the two opposing longitudinal rim panels and to a second corner portion of another one of the two opposing transversal rim panels such that the rim panels are interconnected at the fourth corner by the plastic film. Additionally, the plastic film is attached to the other one of the two opposing longitudinal rim panels, between the third corner and fourth corner of the tray. With such a design, it should be noted that the plastic film is not attached to transversal rim panels, to the corner portions of the side wall panels, to the side wall panels or to the bottom panel of the tray. Thus, the plastic film is only attached to the four corners, interconnecting the respective rim panel, and along the longitudinal rim panels.

It should be noted that any combination of the above stated alternatives or additions may be used as well. Thus, the plastic film may be attached at one or two transversal rim panels, between two corners, respectively and/or at one or two longitudinally rim panels, between two corners, respectively. However, in a preferred embodiment, the rim panels are only interconnected at the first and second corners and along one of the transversal rim panels by the plastic film. It should be understood by the skilled person that when the rim panels are interconnected only at the first and second corners and along the transversal rim panel by the plastic film, the plastic film is not attached to the other corners, along the other rim panels, at corner portions of the side wall panels, along the side wall panels or at the bottom panel of the tray.

The plastic film may extend circumferentially along the circumferential rim of the tray. With such a design, it may be referred to as the plastic film extends around a mouth of the tray. The plastic film is attached to each of the rim panels, between the respective corners. With such a design, where the plastic film extends along the rim of the tray, there is provided a further improved strength and stability of the tray, both when stacking one tray on top of the other but also when filling the tray with the desired content.

At at least the first corner of the tray, the plastic film may be attached at least to a first corner portion of one of the two opposing longitudinal side wall panels and to a first corner portion of one of the two opposing transversal side wall panels such that said side wall panels are interconnected at the first corner by said plastic film. In this context, it may be noted that in a preferred embodiment, the plastic film is only attached to the first corner portion of one of the two opposing longitudinal side wall panels and to the first corner portion of one of the two opposing transversal side wall panels. Thus, the side wall panels are only interconnected at the first corner by the plastic film.

With such a design, where the plastic film is attached such that the side wall panels are interconnected at at least the first corner by the plastic film, there is provided a strong, stable but also robust tray both when stacking the plurality of trays on top of each other and when filling the tray with the desired content. This also provides for at least one leak-tight corner of the tray. Further, with such a design, there is provided an easy and efficient solution of keeping the tray in the folded state. This facilitates provision of keeping the tray in the folded state without the use of any adhesive or similar means, or at least with a minimum use of such adhesive or similar means.

Again, in this context, it may be noted that in a preferred embodiment, the tray has four corners. Thus, alternatively, or additionally, at a second corner of the tray, the plastic film may be attached to a first corner portion of another one of the two opposing longitudinal side wall panels and to a second corner portion of the one of the two opposing transversal side wall panels such that the side walls panels are interconnected at the second corner by the plastic film. In this context, it may be noted that in a preferred embodiment, the plastic film is only attached to the first corner portion of the other one of the two opposing longitudinal side wall panels and to the second corner portion of the one of the two opposing transversal side wall panels. With such a design, the side wall panels are interconnected only at the second corner of the tray by the plastic film. Further, with such a design, the plastic film is not attached to any other components of the tray.

Alternatively, or additionally, at a third corner of the tray, the plastic film may be attached to a second corner portion of one of the two opposing longitudinal side wall panels and to a first corner portion of another one of the two opposing transversal side wall panels such that the side wall panels are interconnected at the third corner by the plastic film. In this context, it may be noted that in a preferred embodiment, the plastic film is only attached to the second corner portion of one of the two opposing longitudinal side wall panels and to the first corner portion of the other one of the two opposing transversal side wall panels. With such a design, the side wall panels are interconnected only at the third corner of the tray by the plastic film. Further, with such a design, the plastic film is not attached to any other components of the tray.

Alternatively, or additionally, at a fourth corner of the tray, the plastic film may be attached to a second corner portion of another one of the two opposing longitudinal side wall panels and to a second corner portion of the one of the other one of the two opposing transversal side wall panels such that the side wall panels are interconnected at the fourth corner by the plastic film. In this context, it may be noted that in a preferred embodiment, the plastic film is only attached to the second corner portion of the other one of the two opposing longitudinal side wall panels and to the second corner portion of the one of the two opposing transversal side wall panels. With such a design, the side wall panels are interconnected only at the fourth corner of the tray by the plastic film. Further, with such a design, the plastic film is not attached to any other components of the tray.

In a preferred embodiment, the side wall panels are only interconnected at one corner of the plurality of corners of the tray by the plastic film. The side wall panels may be interconnected at one or more corners of the tray by the plastic film. It should be noted that the “first, second, third, fourth” should only be seen as labels and the first corner may be any corner of the above alternative etc.

If all corners of the tray are provided with the plastic film, there is provided an easy and efficient solution of forming a tray which comprises a barrier in an inside area of the tray. Thus, there is provided a leak-tight tray.

At a second corner of the tray, the plastic film may be further attached to a first corner portion of another one of the two opposing longitudinal side wall panels and to a second corner portion of said one of the two opposing transversal side wall panels such that said side wall panels are interconnected at the second corner by said plastic film, and
wherein, the plastic film may be further attached to said one of the two opposing transversal side wall panels, between the first corner and the second corner of the tray.

With such a design, where the plastic film is attached to the second corner of the tray and to one of the two opposing transversal side wall panels, between the first and second corner of the tray, there is provided an improved strength and stability of the tray, both when stacking one tray on top of the other but also when filling the tray with the desired content. In this context, it may be noted that in a preferred embodiment, the plastic film is only attached to the side wall panels at the first and second corner of the tray and to one of the two transversal side wall panels, between the first and second corner. Thus, the plastic film is not attached to the other corners of the tray or along other side wall panels. The plastic film is neither attached to the corner portions of the rim panels, to the rim panels or to the bottom panel of the tray. Alternatively, or additionally, at a third corner of the tray, the plastic film may be attached to a second corner portion of one of the two opposing longitudinal side wall panels and to a first corner portion of another one of the two opposing transversal side wall panels such that the side wall panels are interconnected at the third corner by the plastic film. Alternatively, or additionally, at a fourth corner of the tray, the plastic film may be attached to a second corner portion of another one of the two opposing longitudinal side wall panels and to a second corner portion of the one of the other one of the two opposing transversal side wall panels such that the side wall panels are interconnected at the fourth corner by the plastic film. Additionally, the plastic film is further attached to the other one of the two opposing transversal side wall panels, between the third corner and the fourth corner of the tray. With such a design, it should be noted that the plastic film is not attached to longitudinal side wall panels, to the corner portions of the rim panels, to the rim panels or to the bottom panel of the tray. Thus, the plastic film is only attached to the four corners, interconnecting the respective side wall panel, and along the transversal side wall panels.

Alternatively, or additionally, at the third corner of the tray, the plastic film is attached to a second corner portion of one of the two opposing longitudinal side wall panels and to a first corner portion of another one of the two opposing transversal side wall panels such that the side wall panels are interconnected at the third corner by the plastic film. Additionally, the plastic film is attached to the one of the two opposing longitudinal side wall panels, between the first corner and third corner or between the second corner and third corner of the tray. With such a design, it should be noted that the plastic film is not attached to the other transversal side wall panel, the other longitudinal side wall panels, to the corner portions of the rim panels, to the rim panels or to the bottom panel of the tray. Thus, the plastic film is only attached to the three corners, interconnecting the respective side wall panel, along one of the transversal side wall panels and along one of the longitudinal side wall panels.

In this context, it may be noted that there are several different variants available within the definition of “second corner of the tray”, wherein the first variant is stated above. In a second variant, the plastic film is attached to a second corner portion of the one of the two opposing longitudinal side wall panels and to a first corner portion of another one of the two opposing transversal side wall panels such that the side wall panels are interconnected at the second corner by the plastic film. In this variant, the plastic film may further be attached to the one of the two opposing longitudinal side wall panels, between the first corner and second corner of the tray.

Alternatively, or additionally, at the third corner of the tray, the plastic film is attached to a first corner portion of another one of the two opposing longitudinal side wall panels and to a second corner portion of one of the two opposing transversal side wall panels such that the side wall panels are interconnected at the third corner by the plastic film. Alternatively, or additionally, at the fourth corner of the tray, the plastic film may be attached to a second corner portion of the other one of the two opposing longitudinal side wall panels and to a second corner portion of another one of the two opposing transversal side wall panels such that the side wall panels are interconnected at the fourth corner by the plastic film. Additionally, the plastic film is attached to the other one of the two opposing longitudinal side wall panels, between the third corner and fourth corner of the tray. With such a design, it should be noted that the plastic film is not attached to transversal side wall panels, to the corner portions of the rim panels, to the rim panels or to the bottom panel of the tray. Thus, the plastic film is only attached to the four corners, interconnecting the respective side wall panel, and along the longitudinal side wall panels.

It should be noted that any combination of the above stated alternatives or additions may be used as well. Thus, the plastic film may be attached at one or two transversal side wall panels, between two corners, respectively and/or at one or two longitudinally side wall panels, between two corners, respectively.

The plastic film may be attached to the bottom panel of the tray. With such a design, there is provided an improved strength and stability of the bottom panel. This facilitates both when stacking the plurality of trays on top of each other but also when filling the tray with the desired content.

The plastic film may be attached to inside surfaces of the longitudinal and transversal side wall of the tray. The plastic film is attached to each of the rim panels, between the respective corners. With such a design, where the plastic film is attached to inside surfaces of the side walls, there is provided a further improved strength and stability of the tray, both when stacking one tray on top of the other but also when filling the tray with the desired content.

The blank may be made of a paper-based material, such as a corrugated paperboard or a solid paperboard. Paper-based material may provide a lightweight package. Paper-based material is environmentally friendly and can be recycled in a simple manner. Paper-based material may provide a tray that is easy to transport and handle before the tray is formed to the tray. It may be noted that the blank may be made of other materials. It may be noted that the blank as a whole may be made of paper-based material. It may be noted that the blank need not to be made of the same material through-out. Corrugated paperboard and solid paperboard are advantageous as they are examples of rigid cardboards which provides for that a strong and stable tray may be formed.

The board used may be a multiply paperboard or a corrugated board. The board preferably has high bending stiffness. It is necessary that the board used has a high bending stiffness in order to be able to form a sufficiently steady package. The grammage of the paperboard or corrugated board is preferably in the range of 180-600 g/m2, preferably in the range of 240 to 450 g/m2.

Corrugated board (sometimes referred to as corrugated cardboard or corrugated fiberboard) is a packaging material which can be converted to different types of packaging solutions. Corrugated board is a fiber based material made from cellulose fibers. The fibers can be virgin fibers or recycled fibers, such as fibers from used corrugated cardboard or other materials.

The corrugated board comprises at least one corrugated medium (fluting) and at least one non-corrugated medium (liner or linerboard) glued onto a surface of the corrugated medium. For example, the corrugated board may consist of a layer of fluting glued between two layers of liner to form a sandwich structure. The sandwich structure can be formed in different ways such as in single, double, and triple walls as described, e.g., in Kirwan M., J., Paper and Paperboard. Packaging Technology, Blackwell Publishing 2005.

There are different kinds of corrugated board qualities, and these may comprise different types of liners and corrugated media. Containerboard (also known as CCM or corrugated case material) is a type of paperboard specially manufactured for the production of corrugated board. It includes both linerboard and corrugating medium (or fluting), the two types of paper that make up corrugated board. Since containerboard is made mainly out of natural unbleached wood fibers, it is generally brown, although its shade may vary depending on the type of wood, pulping process, recycling rate and impurities content.

Examples of different types of liners are kraftliner and testliner. Kraftliner is typically produced from kraft pulp that can be bleached or unbleached and may comprise one or more layers/plies wherein the top layer/ply is often optimized to provide a good printing surface and good moisture resistance. Testliner is mainly produced from recycled corrugated board and is commonly manufactured in two layers/plies. Due to the presence of recycled fibers, testliner may typically have lower mechanical strength, particularly lower burst strength, than kraftliner. Kraftliner is frequently used in packaging boxes with higher demands on strength properties.

Fluting is formed from paper or paperboard which has been corrugated using heat, moisture and pressure using a corrugator.

The package produced from the board preferably has a box compression test (BCT) value of at least 250 N, preferably between 300-1000 N, even more preferred between 500-800 N. The BCT value was measured according to Fefco Testing method N° 50.

According to the invention board is manufactured from a base pulp comprising cellulosic fibers. The board may be manufactured in any conventional paper or board making process and machine, known to the skilled person. The base pulp may be any one of a chemical pulp, mechanical pulp, thermomechanical pulp and chemi-thermomechanical pulp (CTMP), and neutral sulphatic semi-chemical (NSSC) pulp. The base pulp may further be any one of a virgin and a re-cycled pulp.

At the circumferential rim, a top sealing film may be attached, wherein the top sealing film extends in a plane between the rim panels and closes a mouth of the tray formed by the circumferential rim.

With such a design, there is provided an easy and efficient way of closing the tray such that the content provided in the tray is kept in the tray. The top sealing film may be a plastic film or the like. The top sealing film is preferably easy to remove from the tray such that the tray and the top sealing film may be recycled separately. This is further advantageous as it allows for stacking the plurality of trays on top of each other although the trays may be filled with content thereby the filled trays may be both easy to store and to transport.

It should be noted that the top sealing film is attached to the plastic film, where the plastic film is attached to one or more corners of the tray. It should further be noted that the top sealing film is attached to the plastic film, where the plastic film is attached to one or more rim panels, between two corners respectively.

The blank may further comprise a lid panel being foldably connected to one of the two opposing longitudinal rim panels on a side thereof being opposite the longitudinal side wall panel to which the longitudinal rim panel is connected or to one of the two opposing transversal rim panels on a side thereof being opposite the transversal side wall panel to which the transversal rim panel is connected, wherein the lid panel is configured to be folded inwardly relative to said longitudinal or transversal rim panel.

The lid panel may be configured to form a lid of the tray. The lid panel is typically folded inwardly in relation to the rim panel when the top sealing film has been attached to the circumferential rim. Thereby, the lid may be designed to improve the stability and strength of the tray but also to protect the top sealing film in an easy way. Preferably, as the blank is folded to form the tray, the bottom panel and the lid panel are arranged in parallel planes.

The lid panel may be designed to extend in a plane between the rim panels and close the mouth of the tray formed by the circumferential rim. With such a design, where the lid panel fully closes the mouth of the tray, there is provided a tray with full security of the content filled in the tray. This is especially advantageous during delivery of the tray. The lid panel may be designed to extend in a plane between one or more of the rim panels and partly close the mouth of the tray formed by the circumferential rim.

The blank may comprise a first lid panel and a second lid panel being foldably connected to a respective one of the two opposing longitudinal rim panels on a side thereof being opposite the longitudinal side wall panel to which the respective longitudinal rim panel is connected or to a respective one of the two opposing transversal rim panels on a side thereof being opposite the transversal side wall panel to which the respective transversal rim panel is connected, wherein the first and second lid panels are configured to be folded inwardly relative to the respective longitudinal or transversal rim panel.

The first and second lid panels may be configured to form a lid of the tray. The first and second lid panels are typically folded inwardly in relation to the respective lid panel when the top sealing has been attached to the circumferential rim. Thereby, the first and second lid panels may be designed to improve the stability and strength of the tray but also to protect the top sealing film in an easy way. Preferably, as the blank is folded to form the tray, the bottom panel, the first lid panel and the second lid panel are arranged in parallel planes.

The first and second lid panels may be designed to extend in a plane between the rim panels and to partly close the mouth of the tray formed by the circumferential rim respectively. The first and second lid panels may together be configured to fully close the mouth of the tray formed by the circumferential rim. With such a design, where the lid is formed by the first and second lid panels, there is provided a lid which may be designed in various way relating to both shape and size.

The blank may further comprise a flap panel,
wherein the flap panel is foldably connected to the lid panel on a side thereof being different than, preferably orthogonal to, the longitudinal or transversal rim panel to which the lid panel is connected, the flap panel being configured to be folded inwardly relative to the lid panel towards and be attached to an outside surface of a side wall of the tray being different than, preferably orthogonal to, the side wall panel of the blank to which the lid panel is connected via said longitudinal or transversal rim panel, or
wherein the flap panel is foldably connected to one of the two opposing longitudinal rim panels on a transversal side thereof or to one of the two opposing transversal rim panels on a longitudinal side thereof, the flap panel being configured to be folded inwardly relative to the rim panel towards and be attached to an outside surface of a side wall panel to which the rim panel is connected.

With such a design, there is provided a tray with improve strength and stability. The flap panel is typically configured to receive parts of outside loads which may be provided to the tray, especially during transport of the tray. The flap panel may be designed to cover at least a portion of the outside surface of the side wall panel. The flap panel may be designed as an additional support for the tray such that the stability and strength of the tray is improved. In this context, the term “attached” should be interpreted as the flap panel may be adhesively attached, heated sealed or the like.

In this context, it should be noted that the blank may comprise more than one flap panel being configured to act as a support panel for the tray. If there is more than one flap panel it is preferred that the flap panels are arranged on opposite sides. The flap panels may e.g., be positioned on opposite side of the same lid panel. Alternatively, the flap panels may be arranged on opposite sides of a respective one of the lid panels, such that the flap panels are diagonally arranged as seen relative to the bottom panel.

According to a second aspect, there is provided a method for forming a tray from a blank, the method comprising:
providing a blank which comprises:
   a bottom panel;
   two opposing longitudinal side wall panels being foldably connected to a respective one of two opposing longitudinally extending sides of the bottom panel;
   two opposing transversal side wall panels being foldably connected to a respective one of two opposing transversely extending sides of the bottom panel;
   two opposing longitudinal rim panels being foldably connected to a respective one of the two opposing longitudinal side wall panels on a longitudinally extending side of the respective longitudinal side wall panels being opposite the bottom panel, and
   two opposing transversal rim panels being foldably connected to a respective one of the two opposing transversal side wall panels on a transversely extending side of the respective transversal side wall panel being opposite the bottom panel,
folding the side wall panels upwardly relative to the bottom panel to form a respective side wall of the tray,
folding the rim panels outwardly or inwardly relative to the respective side wall to form a rim of the tray, and
attaching one or more plastic film pieces (235) to the respective rim panels at at least a first, second, third and fourth corner of the tray, such that the one or more plastic film pieces is/are attached to a respective first corner portion and second corner portion of the longitudinal rim panels and to a respective first corner portion and second corner portion of the two opposing transversal rim panels such that said rim panels are interconnected at the first, second, third, and fourth corner by said plastic film,
wherein the respective first and a second corner portion of each respective rim panel are arranged on opposite sides of a respective central portion as seen along a respective main extension of the respective rim panel.

The step of attaching the plastic film at at least the first corner of the tray may comprise:
heating and pressing the plastic film at at least the first corner of the tray such that the plastic film is laminated to the at least the first corner of the tray.

The method may further comprise attaching a top sealing film to the circumferential rim of the tray by heating and pressing the top sealing film to the circumferential rim of the tray, such as by using ultra-sonic sealing.

The method may further comprise sealing the edge corners, formed by the geometrical line-shaped intersections between the adjacent side wall panels, by using ultra-sonic sealing to form a gas-tight tray. The edge corners each has a mainly vertical extension.

The ultra-sonic sealing of the edge corners of the tray may be performed before or after the top sealing film is attached to the circumferential rim of the tray.

The advantages associated with the various features of the tray have been discussed in detail above in relation to the tray and that discussion is equally applicable to the features of the method.

This is further advantageous as it allows for forming the tray in an easy and efficient way in which no separate tray former is needed. Thus, a simpler automation and material handling process compared to conventional solution is achieved.

By using ultra-sonic sealing in the geometrical intersections between the adjacent side wall panels it is possible to form a gas-tight tray without the need of a plastic liner or adhesive.

In this context, it should be noted that in a preferred embodiment, the folding of the blank and attaching the plastic film may be simultaneously performed in one automated unit. The method may further comprise, prior to folding the blank and attaching the plastic film, die-cutting the blank and the plastic film.

The disclosure may also in short be said to relate to a tray formed from a blank comprising: a bottom panel; two opposing longitudinal side wall panels; two opposing transversal side wall panels; two opposing longitudinal rim panels; and two opposing transversal rim panels, wherein the side wall panels are folded upwardly relative to the bottom panel to form a respective side wall of the tray, and thereby forming corners in geometrical intersections between the adjacent side wall panels, wherein the rim panels are folded outwardly or inwardly relative to the respective side wall to form a circumferential rim of the tray, and wherein, at at least a first corner of the tray, a plastic film is attached at least to a first corner portion of one of the two longitudinal rim panels and to a first corner portion of one of the two transversal rim panels such that said rim panels are interconnected at the first corner by said plastic film.

It may be noted that the use of first, second, third, fourth, etc. are mainly to be seen as labels facilitating reading and that it does not necessarily mean that there need to be all the intervening numbers of panels or fold lines present. However, to facilitate reading, the numbering first, second, third, fourth, etc., have consistently been used as labels, and in a sense the numbering is based on an embodiment including all conceivable panels.

It may also be noted that panel names such as bottom, side wall and rim are intended meant to be read as labels, not necessarily defining the orientation of the panel.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1a discloses a blank for forming a tray according to the present disclosure.

FIG. 1b discloses a variant of a blank for forming a tray according to the present disclosure.

FIG. 1c discloses a further variant of a blank for forming a tray according to the present disclosure.

FIG. 2 discloses a tray formed from a blank as disclosed in FIG. 1.

FIG. 3 discloses a tray formed from a blank as disclosed in FIG. 1.

FIG. 4 discloses a tray formed from a blank as disclosed in FIG. 1, wherein the tray comprises a top sealing film.

FIG. 5 discloses a variant of a tray formed from a blank.

FIG. 6 discloses a further variant of a tray formed from a blank.

FIG. 7 discloses a perspective view of the further variant of the tray formed from a blank as disclosed in FIG. 4.

### DESCRIPTION OF EMBODIMENTS

The present invention will now be described more fully hereinafter with reference to the accompanying drawings, in which currently preferred embodiments of the invention are shown. This invention may, however, be embodied in many different forms and should not be constructed as limited to the embodiments set forth herein; rather, these embodiments are provided for thoroughness and completeness, and fully convey the scope of the invention to the skilled person.

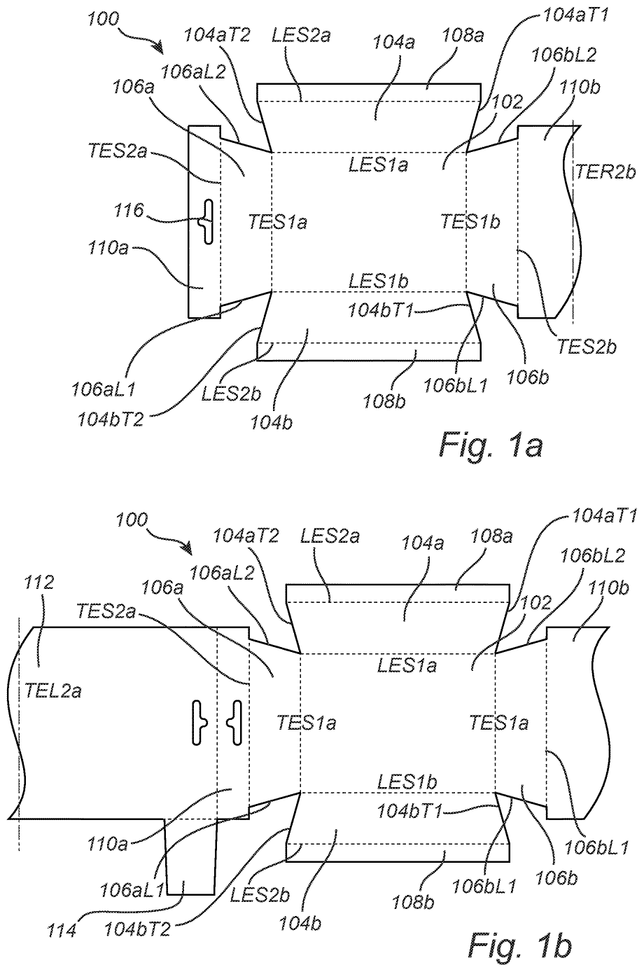

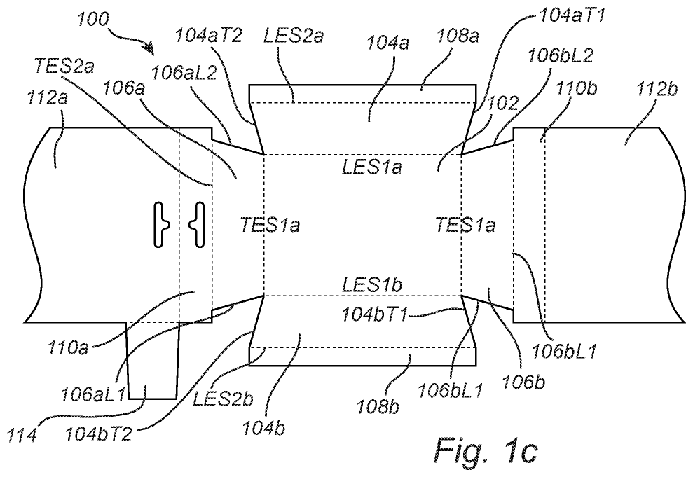

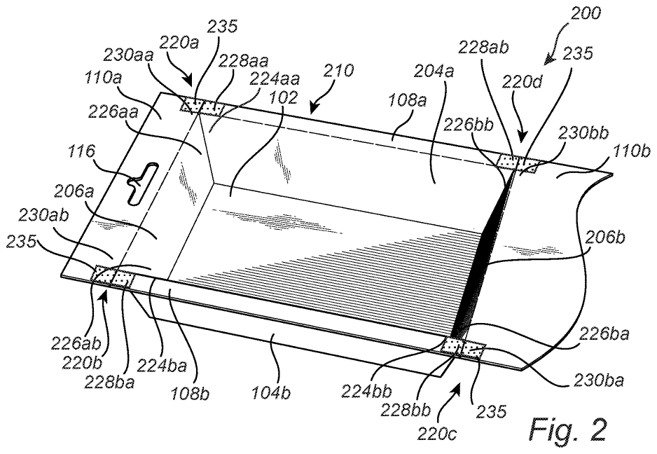

With reference to FIG. 1a, a blank 100 is illustrated by way of example. The blank 100 is typically designed to be folded to form a tray 200. The tray 200 is further illustrated and discussed in connection with FIGS. 2 to 6.

The blank 100 comprises a bottom panel 102, two opposing longitudinal side wall panels 104a-b and two opposing transversal side wall panels 106a-b. The longitudinal side wall panels 104a-b are foldably connected to a respective one of two opposing longitudinal extending sides LES1a-b of the bottom panel 102. The transversal side wall panels 106a-b are foldably connected to a respective one of two opposing transversely extending sides TES1a-b of the bottom panel 102. The side wall panels 104a-b, 106a-b are configured to be folded upwardly relative to the bottom panel 102 (or outwardly as seen in FIG. 1a) to form a respective side wall 204a-b, 206a-b of the tray 200 (as best seen in FIGS. 1b to 5). As depicted in FIG. 1a, the longitudinal side wall panels 104a-b are designed with substantially transversely extending end sides 104aT1, 104aT2, 104bT1, 104bT2. The transversal side wall panels 106a-b are designed with substantially longitudinally extending end sides 106aL1, 106aL2, 106bL1, 106bL2.

The blank 100 further comprises two opposing longitudinal rim panels 108a-b and two opposing transversal rim panels 110a-b. The longitudinal rim panels 108a-b are foldably connected to a respective one of the two longitudinal side wall panels 104a-b on a longitudinally extending side LES2a-b of the respective longitudinal side wall panels 104a-b. The longitudinally extending sides LES2a-b of the respective longitudinal side wall panels 104a-b are opposite the bottom panel 102. The transversal rim panels 110a-b are foldably connected to a respective one of the two transversal side wall panels 106a-b on a transversely extending side TES2a-b of the respective transversal side wall panel 106a-b. The transversely extending sides TES2a-b of the respective transversal side wall panel 106a-b are opposite the bottom panel 102. The rim panels 108a-b, 110a-b are configured to be folded outwardly or inwardly relative to the respective side wall 204a-b, 206a-b of the tray 200 to form a circumferential rim 210 of the tray 200 comprising rims 208a-b, 210a-b of the tray 200 (as best seen in FIGS. 1b to 5). As depicted in FIG. 1a, the longitudinal rim panels 108a-b are designed in a similar way, being rectangular shaped panels, and the transversal rim panels 110a-b are designed in different ways. One of the rim panels 110a is a rectangular shaped panel having a cut-out 116. The cut-out 116 is typically for hanging the tray 200, when formed from the blank 100, in an easy way. The other one of the rim panels 110b has one transversely extending side TER2b which is wave-shaped.

The blank 100 is typically made of paper-based material such as a corrugated paperboard or a solid paperboard.

With reference to FIG. 1b, a variant design of the blank 100 is illustrated by way of example. Further to what have been discussed in connection with FIG. 1a, the blank 100 comprises a lid panel 112. The lid panel 112 has one transversely extending side TEL2a which is wave-shaped. As depicted in FIG. 1b, the lid panel 112 is foldably connected to one of the transversal rim panels 110a on a side which is opposite the transversal side wall panel 106a to which the transversal rim panel 110a is connected. The lid panel 112 is configured to be folded inwardly relative to the transversal side wall panel 106a. In this context, it should be noted that, although not illustrated, the lid panel 112 may be connected to the other one of the transversal rim panels 110b or to one of the two longitudinal rim panels 108a-b.

The blank 100 further comprises a flap panel 114. As depicted in FIG. 2, the flap panel 114 is foldably connected to the lid panel 112 on a side transversely extending side TEL1a of the lid panel 112. The flap panel 114 is configured to be folded inwardly relative to the lid panel 112 towards an outside surface of a side wall panel 104a-b, 106a-b which is different than the side wall panel 106a to which the lid panel 112 is connected via the rim panel 110a. In this context, it should be noted that, although not illustrated, the flap panel 114 may be connected to one of the two opposing longitudinal rim panels 108a-b on a transversal side thereof or to one of the two opposing transversal rim panels 110a-b on a longitudinal side thereof. The flap panel 114 is configured to be folded inwardly relative to the rim panel 108ab, 110a-b towards an outside surface of a side wall panel 104a-b, 106a-b to which the rim panel 108a-b, 110a-b is connected.

Although not illustrated, the blank 100 may comprise more than one flap panel 114. It is e.g., conceivable to have another flap panel on the opposing side of the lid panel 112. It may also be noted that although the flap panel 114 is disclosed as having a limited extension along the longitudinal direction, it is conceivable that the respective flap panel 114 have a longitudinal extension along the full length of the side wall 104a-b, 106a-b to which it is intended to be attached. It may also be noted that the lid panel 112 may have a longitudinal extension corresponding to the complete length from rim to rim, such as from the fold line between the lid panel 112 and the transversal rim panel 110a to an overlap with, and preferably to the outer edge of, the opposing transversal rim panel 110b. In such a design, the lid panel 112, and the inner portions of the flap panels 114 extending along the full length of the lid panel 112 may be provided with a plastic film on the inside, which plastic film is used to seal the tray after filling the product in the tray. The inner portions of the flap panels 114 is intended to refer to those portions of the flap panels 114 that extend above the rim panels 108a-b, 110a-b before the flap panels 114 are being folded downwardly and inwardly towards the outside surface of the side wall panels 104a-b, 106a-b. In such a design, the tray 200 may be erected and thereafter a plastic film may be used to interconnect the rim panels 108a-b, 110a-b and to the inside of the lid panel 112, and optionally also to the insides of the side wall panels 104a-b, 106a-b and the bottom 102. The plastic film may in such a case be stretched down into the tray 200, in a thermo-forming process, such as by using a mandrel, gas pressure, or under-pressure stretching the plastic film simultaneously as the film is, or after the film has been, selectively heat sealed to the rim panels 108a-b, 110a-b and the lid panel 112. Alternatively, the lid panel 112 and the inner portions of the flap panels 114 may be provided with a plastic film and separate pieces of plastic film is applied to at least the corner portions of the neighboring rim panels 108a-b, 110a-b such that at least the corner portions of the neighboring rim panels 108a-b, 110a-b becomes interconnected.

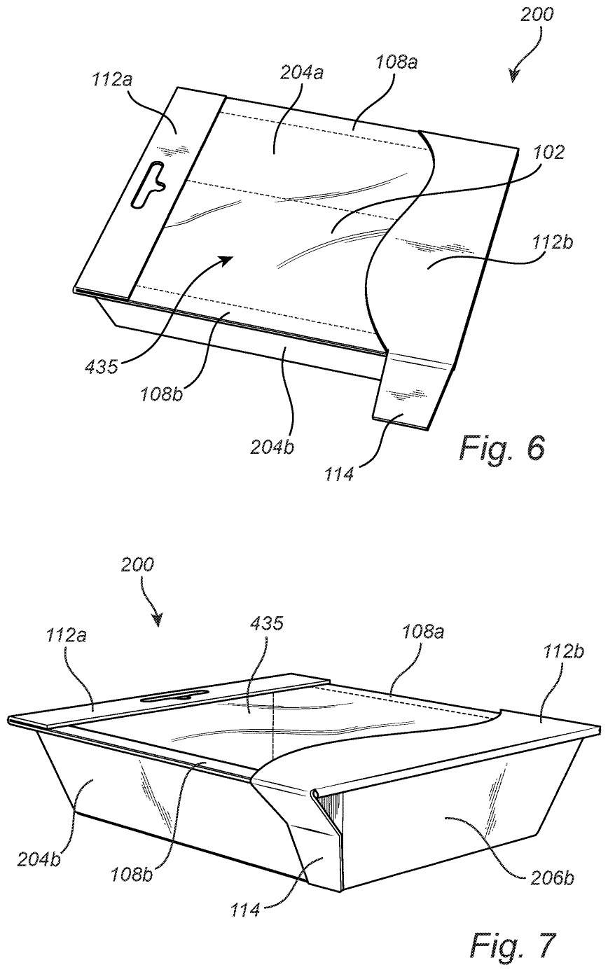

With reference to FIG. 1c, a variant design of the blank 100 is illustrated by way of example. Further to what have been discussed in connection with FIGS. 1a-b, the blank 100 comprises a first lid panel 112a and a second lid panel 112b. As depicted in FIG. 1c, the first lid panel 112a is foldably connected to one of the transversal rim panels 110a on a side which is opposite the transversal side wall panel 106a to which the transversal rim panel 110a is connected and the second lid panel 112b is foldably connected to the other one of the transversal rim panels 110b on a side which is opposite the transversal side wall panel 106b to which the transversal rim panel 110b is connected. As best illustrated in FIGS. 5 to 7, the lid panels 112a, 112b are configured to be folded inwardly relative to the respective transversal rim panel 110a-b. In this context, it should be noted that, although not illustrated, one or both lid panels 112a, 112b may be connected to one of the two longitudinal rim panels 108a-b, respectively. If that is the case, the lid panels 112a, 112b are configured to be folded inwardly relative to the respective longitudinal rim panel 108a-b. As further depicted in FIG. 1c, the flap panel 114 is foldably connected to the first lid panel 112a. As best illustrated in FIG. 6, the flap panel 114 is folded inwardly relative to the first lid panel 112a towards the outside surface of the longitudinal side wall 204b. The flap panel 114 is also attached to the outside surface of the longitudinal side wall 204a. In this context, it should however be noted that the flap panel 114 may be foldably connected to the second lid panel 112b. Although not illustrated, the blank 100 may comprise more than one flap panel 114 being foldably connected to the first lid panel 112a or the second lid panel 112b.

With reference to FIG. 2, the tray 200 as introduced in connection with FIG. 1a is illustrated by way of example. The tray 200 is formed from the blank 100 as illustrated in FIG. 1a, wherein the side wall panels 104a-b, 106a-b have been folded upwardly relative to the bottom panel 102 to form the respective side walls 204a-b, 206a-b. As depicted in FIG. 2, when the side wall panels 104a-b, 106a-b are folded upwardly to form the respective side wall of the tray, the substantially transversely extending end sides 104aT1, 104aT2, 104bT1, 104bT2 (illustrated in FIGS. 1a-c), of the two opposing longitudinal side wall panels 104a-b extend along a respective substantially longitudinally extending end side 106aL1, 106aL2, 106bL1, 106bL2 of the two opposing transversal side wall panels 106a-b. Thereby, corners in geometrical intersections between the adjacent side wall panels 104a-b, 106a-b are formed.

The rim panels 108a-b, 110a-b are folded outwardly relative to the respective side wall 204a-b, 206a-b to form the circumferential rim 210 of the tray 200.

As further depicted in FIG. 2, the tray 200 comprises four corners 220a-d. At the first corner 220a of the tray 200, a plastic film piece 235 is attached to a first corner portion 228aa of the longitudinal rim panel 108a and to a first corner portion 230aa of the transversal rim panel 110a such that the rim panels 108a, 110a are interconnected at the first corner 220a by said plastic film 235. A respective plastic film piece 235 is attached first corner portion 228ba of the other longitudinal rim panel 108a and to a second corner portion 230ab of the transversal rim panel 110a such that the rim panels 108a, 110a are interconnected at the second corner 220a by said plastic film 235. Moreover, a respective plastic film piece 235 is attached to the respective second corner portion 228ab, 228bb of the two opposing longitudinal rim panels 108a-b and to the first and second corner portions 230ba, 230bb, respectively, of one of the two opposing transversal rim panels 110a-b such that said rim panels 108a-b, 110a-b are interconnected at the third and fourth corner 220a by said plastic film 235.

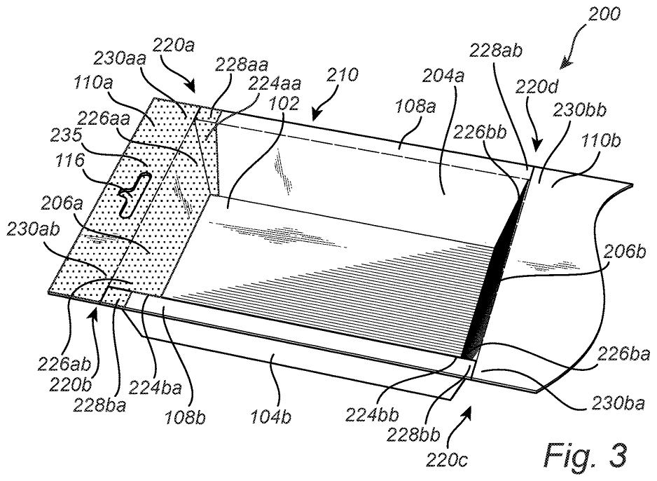

With reference to FIG. 3, a variant of the tray 200 is illustrated by way of example. Further to what have been discussed in connection with FIG. 2, at the first corner of the tray 220a, the plastic film 235 is also attached to a first corner portion 224aa of the longitudinal side wall panel 104a and to a first corner portion 226aa of the transversal side wall panel 106a such that said side wall panels 104a, 106a are interconnected at the first corner 220a by said plastic film 235. At the second corner 220b of the tray 200, the plastic film 235 is attached to a first corner portion 228ba of the other longitudinal rim panel 108b and to a second corner portion 230ab of the transversal rim panel 110a such that the rim panels 108b, 110a are interconnected at the second corner 220b by the plastic film 235. At the second corner 220b of the tray 200, the plastic film 235 is also attached to a first corner portion 224ba of the other longitudinal side wall panel 104b and to a second corner portion 226ab of the transversal side wall panel 106a such that the side wall panels 104b, 106a are interconnected at the second corner 220b by the plastic film 235. The plastic film 235 is further attached to the transversal rim panel 110a and to the transversal side wall panel 106a, between the first and second corners 220a-b of the tray 200.

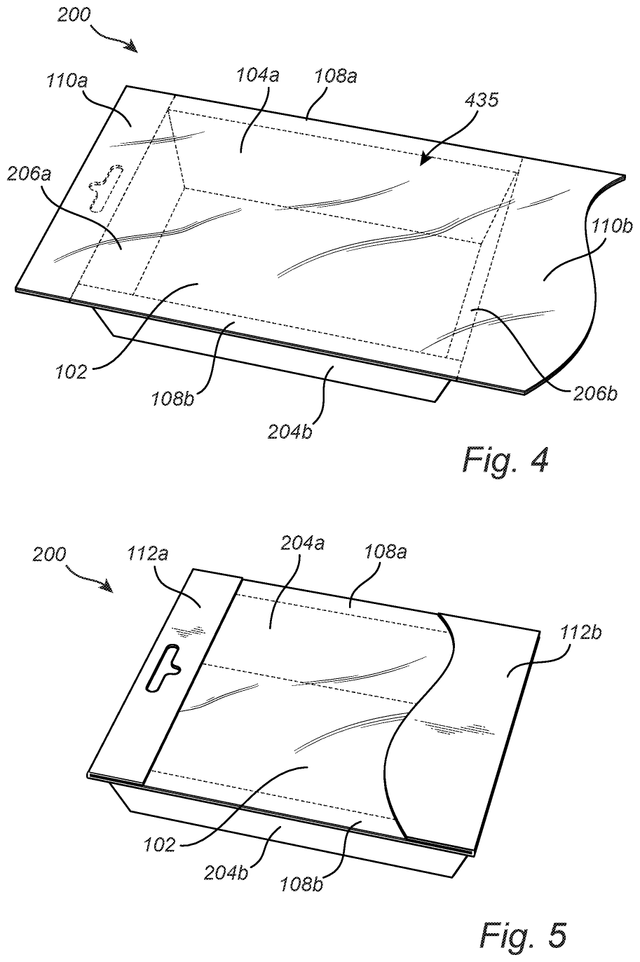

As best illustrated in FIG. 4, the tray 200 further comprises a top sealing film 435. The top sealing film 435 is attached at the circumferential rim 210 of the tray 200 and extends in a plane between the rim panels 108a-b, 110a-b. The top sealing film 435 is configured to close the mouth of the tray 200 formed by the circumferential rim 210. The top sealing film 435 may be attached to the tray 200 by heating and pressing the top sealing film 435 to the circumferential rim 210 of the tray 200. The top sealing 435 may be attached to the tray 200 by using ultra-sonic heating.

As best illustrated in FIGS. 5 to 7, the first and second lid panels 112a, 112b are folded inwardly relative to the respective transversal rim panel 110a, 110b, and arranged above the top sealing film 435.

The person skilled in the art realize that the present invention by no means is limited to the preferred embodiments described above. On the contrary, many modifications and variations are possible within the scope of the appended claims.

It may in this context be noted that whenever it is said that plastic film is attached to something, this attachment may be performed using any conventional method. The plastic film may be adhesively attached using a separate adhesive. However, it is preferred to use a thermoplastic film which may be adhered to the other material, or itself, by being heated and pressed together such that the plastic film and the other material, or the different layers of plastic film adhere to each other once the plastic film returns to ambient temperature. The heating may be provided any conventional means, such as by blowing hot gas, thermo-forming, contact heating, or ultra-sonic heating.

1. A tray formed from a blank, the blank comprising:
a bottom panel;
two opposing longitudinal side wall panels foldably connected to a respective one of two opposing longitudinally extending sides of the bottom panel;
two opposing transversal side wall panels foldably connected to a respective one of two opposing transversely extending sides of the bottom panel;
two opposing longitudinal rim panels foldably connected to a respective one of the two opposing longitudinal side wall panels (104a-b) on a longitudinally extending side of the respective longitudinal side wall panels being opposite the bottom panel, and
two opposing transversal rim panels foldably connected to a respective one of the two opposing transversal side wall panels on a transversely extending side of the respective transversal side wall panel being opposite the bottom panel,
wherein the two opposing longitudinal side wall panels and the two opposing transversal side wall panels are folded upwardly relative to the bottom panel to form a respective side wall of the tray,
wherein, when the side wall panels are folded upwardly to form the respective side wall of the tray, substantially transversely extending end sides, as seen in a flat-laid state of the blank, of the two opposing longitudinal side wall panels each extend along a respective one of the two opposing transversal side wall panels or along a respective substantially longitudinally extending end side of the two opposing transversal side wall panels, or vice versa, and thereby form corners in geometrical intersections between the adjacent side wall panels,
wherein the two opposing longitudinal rim panels and the two opposing transversal rim panels are folded outwardly or inwardly relative to the respective side wall of the tray to form a circumferential rim of the tray,
wherein the longitudinal rim panels and the transversal rim panels each comprises a first corner portion and a second corner portion arranged on opposite sides of a respective central portion as seen along a respective main extension of the respective rim panel,
wherein one or more plastic film pieces is attached to the respective rim panel at at least a first, second, third, and fourth corner of the tray,
wherein the one or more plastic film pieces is attached at least to the respective first corner portion of the two opposing longitudinal rim panels and to the first corner portion and the second corner portion, respectively, of one of the two opposing transversal rim panels such that said rim panels are interconnected at the first corner and the second corner by said plastic film,
wherein the one or more plastic film pieces is attached at least to the respective second corner portion of the two opposing longitudinal rim panels and to the first corner portion and the second corner portion, respectively, of one of the two opposing transversal rim panels such that said rim panels are interconnected at the third corner and the fourth corner by the one or more plastic film pieces,
wherein the one or more plastic film pieces is only attached to said longitudinal rim panels and said transversal rim panels, and
wherein the blank is made of a paper-based material having a grammage in a range of 180-600 g/m².

2. The tray according to claim 1,
wherein, the one or more plastic film pieces is further attached along said one of the two opposing transversal rim panels, between the first corner and the second corner of the tray.

3. The tray according to claim 1,
wherein, the one or more plastic film pieces is further attached along said one of the two opposing transversal side wall panels, between the first corner and the second corner of the tray.

4. The tray according to claim 1, wherein the one or more plastic film pieces extend circumferentially along the circumferential rim of the tray.

5. The tray according to claim 1, wherein, at the circumferential rim, a top sealing film is attached, wherein the top sealing film extends in a plane between the opposing longitudinal rim panels and the transversal rim panels and closes a mouth of the tray formed by the circumferential rim.

6. The tray according to claim 1, wherein the blank further comprises a lid panel foldably connected to one of the two opposing longitudinal rim panels on a side thereof opposite the longitudinal side wall panel to which the longitudinal rim panel is connected or to one of the two opposing transversal rim panels on a side thereof being opposite the transversal side wall panel to which the transversal rim panel is connected, and
wherein the lid panel is configured to be folded inwardly relative to said longitudinal or transversal rim panel.

7. The tray according to claim 1, wherein the blank further comprises a first lid panel and a second lid panel each foldably connected to a respective one of the two opposing longitudinal rim panels on a side thereof being opposite the longitudinal side wall panel to which the respective longitudinal rim panel is connected, or to a respective one of the two opposing transversal rim panels on a side thereof being opposite the transversal side wall panel to which the respective transversal rim panel is connected, and
wherein the first lid panel and the second lid panel are configured to be folded inwardly relative to the respective longitudinal or transversal rim panel.

8. The tray according to claim 7, wherein the blank further comprises a flap panel,
wherein the flap panel is foldably connected to the lid panel on a side thereof being different than the longitudinal rim panel or the transversal rim panel to which the lid panel is connected, the flap panel configured to be folded inwardly relative to the lid panel towards and be attached to an outside surface of a side wall of the tray being different than the side wall panel of the blank to which the lid panel is connected via said longitudinal rim panel or the transversal rim panel, or
wherein the flap panel is foldably connected to one of the two opposing longitudinal rim panels on a transversal side thereof or to one of the two opposing transversal rim panels on a longitudinal side thereof, the flap panel configured to be folded inwardly relative to the rim panel towards and be attached to an outside surface of a side wall panel to which the rim panel is connected.

9. A method for forming a tray from a blank, the method comprising:
providing a blank which comprises:
a bottom panel;
two opposing longitudinal side wall panels foldably connected to a respective one of two opposing longitudinally extending sides of the bottom panel;
two opposing transversal side wall panels foldably connected to a respective one of two opposing transversely extending sides of the bottom panel;
two opposing longitudinal rim panels being foldably connected to a respective one of the two opposing longitudinal side wall panels on a longitudinally extending side of the respective longitudinal side wall panels opposite the bottom panel, and
two opposing transversal rim panels being-foldably connected to a respective one of the two opposing transversal side wall panels on a transversely extending side of the respective transversal side wall panel opposite the bottom panel,
folding the side wall panels upwardly relative to the bottom panel to form a respective side wall of the tray,
folding the rim panels outwardly or inwardly relative to the respective side wall to form a rim of the tray, and
attaching one or more plastic film pieces to the respective rim panels at at least a first, second, third, and fourth corner of the tray such that the one or more plastic film pieces is attached to a respective first corner portion and second corner portion of the longitudinal rim panels and to a respective first corner portion and second corner portion of the two opposing transversal rim panels such that said opposing transversal rim panels and the longitudinal rim panels are interconnected at the first, second, third, and fourth corner by said plastic film,
wherein the respective first corner portion and a second corner portion of each respective rim panel are arranged on opposite sides of a respective central portion as seen along a respective main extension of the respective rim panel.

10. The method according to claim 9, wherein the step of attaching the one or more plastic film pieces at the corners of the tray comprises:
heating and pressing the one or more plastic film pieces at the first, second, third, and fourth corners of the tray such that the one or more plastic film is laminated to the at least the first corner of the tray.

11. The method according to claim 9, further comprising:
attaching a top sealing film to the circumferential rim of the tray by heating and pressing the top sealing film (435) to the circumferential rim of the tray.
